(19) United States
(12) Patent Application Publication
(10) Pub. No.: US 2026/0288146 A1
(43) Pub. Date: Sep. 24, 2026

(54) COOPERATIVE MANEUVERING FOR VEHICLES

(71) Applicant: QUALCOMM Incorporated, San Diego, CA (US)

(72) Inventors: Yue YIN, Beijing (CN); Yan LI, Beijing (CN); Shuping CHEN, Beijing (CN)

(21) Appl. No.: 19/079,283

(22) Filed: Mar. 13, 2025

(51) Int. Cl. G05D 1/46; G05D 1/229; G05D 1/48

(52) U.S. Cl. CPC G05D 1/46; G05D 1/229; G05D 1/48

(57) ABSTRACT

Systems and techniques are described herein for wireless communication. For example, a computing device can transmit a message including location data and route data associated with the apparatus to request adjustment of a route of one or more aerial vehicles. The computing device can receive a response to the message from the one or more aerial vehicles, the response indicating acceptance of the message to adjust the route of the one or more aerial vehicles. The computing device can adjust at least one of the route data of the apparatus based on the response or cause adjustment of the route of the one or more aerial vehicles based on the message.

### FIELD

The present disclosure generally relates to vehicle communications. For example, aspects of the present disclosure include systems and techniques for providing cooperative maneuvering for vehicles.

### BACKGROUND

Wireless communication systems used by vehicles (aerial or otherwise) can allow vehicles to share information associated with the vehicles and information associated with the environment in which the vehicles operate. Wireless communication systems can use a variety if different technologies to transmit and receive messages. Multiple-access technologies can be used allowing for the plurality of vehicles. For example, wireless communication technologies can include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The aforementioned multiple access technologies have been adopted in various telecommunication standards to provide a common protocol that enables communication between various communication devices. Example telecommunication standards incorporating one or more of the different multiple access systems includes 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). NR Sidelink is a communication technology in 5G NR enabling device-to-device (D2D) communication. Aspects of wireless communication can comprise direct communication between devices, such as in aircraft-to-everything (A2X), and/or D2D communication. There exists a need for further improvements in A2X and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for wireless communications. For example, the systems and techniques described herein can be used for wireless communications associated with connected aircrafts and/or aerial vehicles using an ad-hoc network (e.g., A2X). According to at least one illustrative example, a method of wireless communications by an aerial user equipment (UE) is provided. The method includes: determining information indicative of at least one of a location of the aerial UE, a heading of the aerial UE, or a speed of the aerial UE; broadcasting, using a PC5 interface of the aerial UE, a beacon message indicative of the information and an identifier (ID) value corresponding to the aerial UE, wherein the beacon message is broadcast using an ad-hoc network between the aerial UE and one or more additional aerial UEs; and receiving, using the PC5 interface of the aerial UE, one or more additional beacon message broadcasts from the one or more additional aerial UEs, wherein the one or more additional beacon message broadcasts are received using the ad-hoc network.

In some aspects, an apparatus for wireless communication is provided. The apparatus includes at least one memory and at least one processor coupled to the at least one memory and configured to: transmit a message including location data and route data associated with the apparatus to request adjustment of a route of one or more aerial vehicles; receive a response to the message from the one or more aerial vehicles, the response indicating acceptance of the message to adjust the route of the one or more aerial vehicles; and adjust at least one of the route data of the apparatus based on the response or cause adjustment of the route of the one or more aerial vehicles based on the message.

In some aspects, a method for wireless communication is provided. The method includes: transmitting a message including location data and route data associated with the apparatus to request adjustment of a route of one or more aerial vehicles; receiving a response to the message from the one or more aerial vehicles, the response indicating acceptance of the message to adjust the route of the one or more aerial vehicles; and adjusting at least one of the route data of the apparatus based on the response or cause adjustment of the route of the one or more aerial vehicles based on the message.

In some aspects, a non-transitory computer-readable medium is provided having stored thereon instructions that, when executed by at least one processor, cause the at least one processor to: transmit a message including location data and route data associated with the apparatus to request adjustment of a route of one or more aerial vehicles; receive a response to the message from the one or more aerial vehicles, the response indicating acceptance of the message to adjust the route of the one or more aerial vehicles; and adjust at least one of the route data of the apparatus based on the response or cause adjustment of the route of the one or more aerial vehicles based on the message.

In some aspects, an apparatus for wireless communication is provided. The apparatus can include: means for transmitting a message including location data and route data associated with the apparatus to request adjustment of a route of one or more aerial vehicles; means for receiving a response to the message from the one or more aerial vehicles, the response indicating acceptance of the message to adjust the route of the one or more aerial vehicles; and means for adjusting at least one of the route data of the apparatus based on the response or cause adjustment of the route of the one or more aerial vehicles based on the message.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example wireless communications system, in accordance with some examples;

FIG. 2 is a diagram illustrating an example of a disaggregated base station architecture, in accordance with some examples;

FIG. 3 is a block diagram illustrating an example of a computing system of an aerial user equipment (UE), in accordance with some examples;

FIG. 4 is a diagram illustrating an example system stack of an aircraft-to-everything (A2X) communication system, in accordance with some examples;

FIG. 5 is a diagram illustrating an example of a call flow between aerial UEs diagram, in accordance with some examples;

FIG. 6 is a diagram illustrating an example of aerial vehicles communicating over direct communication interfaces (e.g., a cellular-based NR sidelink interface), in accordance with some examples;

FIG. 7 is a diagram illustrating another example of aerial vehicles communicating over direct communication interfaces (e.g., a cellular-based NR sidelink interface), in accordance with some examples;

FIG. 8 is a flow diagram illustrating an example of a process for wireless communications, in accordance with some examples; and

FIG. 9 is a block diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects of the application. However, it will be apparent that various aspects and examples may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims. The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

A sidelink may refer to any communication link between client devices (e.g., UEs, STAs, etc.). For example, a sidelink may support device-to-device (D2D) communications and/or vehicle-to-everything (V2X) communications, message relaying, discovery signaling, beacon signaling, or any combination of these or other signals transmitted over-the-air from one UE to one or more other UEs. In some examples, sidelink communications may be transmitted using a licensed frequency spectrum or an unlicensed frequency spectrum (e.g., 5 GHz or 6 GHz). As used herein, the term sidelink may refer to 3GPP sidelink (e.g., using an NR sidelink interface), Wi-Fi direct communications (e.g., according to a Dedicated Short Range Communication (DSRC) protocol), or using any other direct device-to-device communication protocol.

In some examples, a communication system can be deployed to provide wireless communications associated with aerial vehicles, such as aircrafts and/or other aerial vehicles (also referred to as aerial user equipment (UEs)). For example, air-to-ground (ATG) communications systems can be deployed to provide various telecommunication services associated with aerial UEs. Aerial UEs can include unmanned aerial vehicles (UAVs) and/or unmanned aircraft systems (UASs). An aerial UE can also be referred to as an “aerial vehicle,” “connected aircraft,” a “connected aerial vehicle,” an “airborne device,” an “aerial device,” etc., among various others. In some examples, the aerial UE is a component of the aerial vehicle. As used herein, an aerial vehicle can include any apparatus or device that is configured to or able to fly through the air, such as an airplane (e.g., commercial airplanes, private airplanes, turboprop aircrafts, piston aircrafts, jets, military aircrafts, etc.), an unmanned aerial vehicle (UAV) or drone, a helicopter, an airship (e.g., a blimp or other airship), a glider, or other apparatus or device that is configured to or able to fly. ATG communications systems can be implemented to interface with terrestrial wireless communications systems by positioning terrestrial antennas (e.g., at a base station) in a manner that can communicate with aerial UE antennas while the aerial UE is in flight. In some cases, ATG communications can be used to provide in-flight communication services for airborne devices. In addition, ATG communications can be used to provide aerial UE operations communications (e.g., aerial UE maintenance, flight planning, weather, etc.) and/or air traffic control information, etc.

In some cases, cellular networks may be used to provide coverage to aerial UEs for various services. For example, cellular networks can provide coverage to aerial UEs for control and non-payload communication (CNPC) communications. CNPC communications can include command and control information, telemetry information, etc. In some examples, cellular networks can provide coverage to aerial UEs for PC5-based services. NR sidelink communications and PC5-based services can be associated with device-to-device communications. In some cases, NR sidelink and PC5-based services can include a broadcast remote identifier (ID) (or identification (ID)) and/or cooperative maneuvers using an NR sidelink. Cellular networks can be used to provide NR sidelink (or PC5-based) services in mobile network operator (MNO)-managed spectrum and/or in non-MNO-managed spectrum.

Aerial UE policy configuration can be performed based at least in part on aviation regulations in various countries or regions where aerial UEs operate. For example, aerial UEs may be required to utilize connectivity services and/or flight services in different ways based on the geographical location where the aerial UE is operating. In some cases, aviation regulations may require aerial UEs to broadcast messages to determine cooperative maneuvers (e.g., maneuvers performed by one or more of the aerial vehicles in communication) messages with a greater transmit power and/or a shorter interval when operating over urban areas, crowded airspace, at low altitudes, etc. In some cases, aerial UEs may be required to avoid certain geographical locations or regions for a temporary amount of time (e.g., due to airspace closures over sporting or stadium events, etc.).

Systems, apparatuses, processes (also referred to as methods), and computer-readable media (collectively referred to as “systems and techniques”) are described herein that can be used to provide cooperative maneuvering for vehicles. For example, the systems and can provide cooperative maneuvering (e.g., message protocols for cooperative maneuvering) for aircraft-to-everything (A2X) communications between aerial vehicles (e.g., aircraft).

In some aspects, the systems and techniques can provide A2X communications between a first aerial vehicle (or aerial UEs) and one or more additional aerial vehicles. The plurality of aerial vehicles (e.g., the first aerial vehicle and the one or more additional aerial vehicles) can communicate with one another using a network (e.g., an ad-hoc network) of aerial vehicles. For example, the ad-hoc network can be a non-centralized communication network between the plurality of aerial vehicles. A sidelink (e.g., an NR sidelink) based framework defined by 3GPP can be used by aerial vehicles (including UAVs), to share the cooperative maneuvers between aerial vehicles.

Cooperative maneuvers can refer to coordinated actions performed by and communicated by a plurality of aerial vehicles. Cooperative maneuvers can include various piloting actions executable using one or more aerial vehicles from the plurality to adjust a route of the one or more aerial vehicles. For example, cooperative maneuvers can be performed by multiple aerial vehicles in communication with other aerial vehicles. Cooperative maneuvers can include piloting actions such as adjusting a speed, direction, altitude, heading, etc. of one or more aerial vehicles.

The plurality of aerial vehicles can generate messages indicating information associated with the location (e.g., absolute position in three-dimensional (3D) space and/or a relative position compared to the aerial vehicles in communication), and a route intended to be traveled by the aerial vehicle (e.g., route data). The plurality of aerial vehicles can communicate using a predetermined data structure (e.g., a container or wrapper) for the messages between the aerial vehicles. The aerial vehicles can use the message to negotiate (or determine) a route for each of the aerial vehicles. The aerial vehicles can continuously, or periodically, transmit messages to other aerial vehicles indicating where each aerial vehicle is within the environment and the route of each aerial vehicle (e.g., where the aerial vehicle is traveling over a predetermined period of time).

In one illustrative example, the cooperative maneuver message broadcast by an aerial vehicle (also referred to as an aerial UE) can correspond to the example message and response format below:

```
AircraftIntentionRequestResponse ::= SEQUENCE {
  msgCnt MsgCount,
  id OCTET STRING (SIZE(8)), -- aircraft ID
  secMark DSecond,
  refPos Position3D, -- aircraft position, including longitude, latitude and
  altitude
  intReqRsp IRRData, -- aircraft intention, request and response
  aircraftAddInfo AircraftAddInfo OPTIONAL,
  source IntentionSource OPTIONAL,
  }
```

In some aspects, the AircraftIntentionRequestResponse message can be transmitted from a first aerial vehicle to one or more additional aerial vehicles. In further examples, the one or more additional aerial vehicles can transmit an AircraftIntentionRequestResponse message or a response to a AircraftIntentionRequestResponse received by the one or more aerial vehicles. In some examples, the AircraftIntentionRequestResponse data structure can be used as a message and a response to a message. In such an example, the message and the response to the message can use the same type of data structure (e.g., the AircraftIntentionRequestResponse data structure).

In such an example, the msgCnt data type can be associated with a number of messages (e.g., an incrementable counter) indicating the number of messages (e.g., AircraftIntentionRequestResponse or other messages) received by an aerial vehicle. The id OCTET STRING (SIZE (8)) can represent an identifier (e.g., an aerial vehicle identification (ID) number) of the aerial vehicle which generated and transmitted the AircraftIntentionRequestResponse. In such an example, the identifier can be an eight digit number associated with the aerial vehicle.

The secMark data type can be associated with a timestamp of the aerial vehicle. For example, the DSecond can represent a timestamp of when the AircraftIntentionRequestResponse was generated or transmitted. The refPos data type can be associated with 3D position of the aerial vehicle. For example, the Position3D variable can include aerial vehicle (also referred to as aircraft) longitude, aerial vehicle latitude, and aerial vehicle altitude to provide the location of the aerial vehicle in 3D space.

The intReqRsp data type can be associated with a request by the aerial vehicle transmitting the AircraftIntentionRequestResponse to perform a cooperative measure. For example, the IRRData of intReqRsp can include route information of the aerial vehicle, such as a sequence of expected waypoints of the aerial vehicle when performing a route and can represent a request to perform the route. For example, the waypoints can include expected location data and times of the aerial vehicle when performing the route. The information of the IRRData can be updated based on responses from the additional aerial vehicles. In such an example, the aerial vehicle can perform piloting operations based on steering data to pilot the aerial vehicle based on the updated route. For example, the steering data can indicate an intended piloting operation to be performed as a cooperative maneuver.

In one illustrative example, the intReqRsp data type of the cooperative maneuver message broadcast by the aerial vehicle can correspond to the example format below:

```
IRRData ::= SEQUENCE {
  pathPlanning PathPlanning OPTIONAL,-- real time
  path planning that is
  shared with neighbors
  driveIntention DriveIntention OPTIONAL, -- current route and target
  route, intended drive behavior
  reqs SEQUENCE (SIZE(X)) -- of DriveRequest OPTIONAL,
  rsps SEQUENCE (SIZE(X)) -- of DriveResponse OPTIONAL,
  }
```

In some aspects, the intReqRsp data type can include one or more of the optional data type representations of a route to be performed by the aerial vehicle. For example, the intReqRsp data type can include the pathPlanning data type. The pathPlanning data type can represent a real time path planning sequence of waypoints of the aerial vehicle. For example, the pathPlanning data type can represent a sequence of intended waypoints over a predetermined period of time. In such an example, the predetermined period of time can be 10 seconds, and each second can be represented as 10 waypoints (e.g., a sequence of waypoints including 10 waypoints per second). In such an example, the pathPlanning data type can include a sequence of waypoints including 100 waypoints of the aerial vehicle.

In such an example, the pathPlanning data type can be represented as the following data structure.

```
pathPlanning ::= SEQUENCE (SIZE(MAXPOINTS)) --
of PathPlanningPoint
MAXPOINTS can be vary based on the path length
PathPlanningPoint ::= SEQUENCE {
  pos PositionOffset, -- location in the path
  speed Speed OPTIONAL,
  heading Heading OPTIONAL, -- Target speed
  and heading when passing
  the target position
  }
```

In some aspects, the points of the waypoints can include a position offset (e.g., pos PositionOffset) representing a location of the aerial vehicle when performing the route. The waypoints can include an expected or intended speed of the aerial vehicle when performing the route (e.g., speed Speed). In another example, the waypoints can include a heading of the aerial vehicle (e.g., heading Heading). In such an example, the heading can be represented as a horizontal angle from north direction of the aerial vehicle. The heading can include a vertical angle from a zenith direction of the aerial vehicle. The horizontal angle and the vertical angle can be included as the Heading of data type heading. In some examples, the waypoints can indicate an intended route of the aerial vehicle including an expected latitude, an expected longitude, and an expected altitude of the aerial vehicle over a predetermined period of time (e.g., the amount of time represented in the sequence of path planning points PathPlanningPoint).

In another example, the intReqRsp data type can include a driveIntention data type. Below is an example data structure representing the driveIntention data type.

```
DriveIntention ::= SEQUENCE {
  currentRt RouteInfo,
  targetRt RouteInfo,
  driveBehavior DriveBehavior,
  }
```

The driveIntention data type can include information associated with where the aerial vehicle began a route (e.g., as starting location indicated by currentRt RouteInfo) and a target location of the aerial vehicle (e.g., a target location where an aerial vehicle is to travel indicated by targetRt RouteInfo). In some examples, the driveIntention data type can indicate a piloting action to be performed by the aerial vehicle (e.g., driveBehavior DriveBehavior). For example, the driveIntention data type can indicate the aerial vehicle intends to maintain direction, change course (e.g., move left or right), adjust elevation, stop and hover, decrease speed, increase speed, etc.

In another example, the intReqRsp data type can include a request (e.g., reqs) and/or a response (rsps). The sequence size (e.g., the size of the request and the response) can vary based on the number of aerial vehicles which can receive and respond to the AircraftIntentionRequestResponse message.

An example data structure for a request (e.g., a message including reqs of the intReqRsp data type) is included below.

```
DriveRequest ::= SEQUENCE {
  reqID INTEGER, -- local ID of this request, -- request/response in serial
  IRR messages can use the same reqID
  reqStatus Status,
  reqPriority OCTET STRING (SIZE(1)) OPTIONAL,
  targetAircraftList AircraftIDList OPTIONAL, --
  the ID of target aircrafts
  lifeTime TimeOffset OPTIONAL, -- valid lifetime of this request,
  calculated from secMark of this message
  }
```

In such an example, the reqs data type (represented as a sequence of variables DriveRequest) can include reqID representing an integer counter identifying the request. In examples where multiple messages are transmitted between the aerial vehicles, the reqID can be the same ID value for subsequent messages and responses associated with the request (e.g., the initial message requesting cooperative maneuvers).

The reqStatus data type can indicate a status of the aerial vehicle transmitting the message, such as indicating whether the aerial vehicle has confirmed a cooperative maneuver to be performed by one or more aerial vehicles in communication, whether an aerial vehicle has cancelled a cooperative maneuver, whether an aerial vehicle is performing a cooperative maneuver, whether an aerial vehicle has accepted a message (e.g., the request) to perform the cooperative maneuver, and whether the aerial vehicle has rejected a message to perform the cooperative maneuver.

The reqPriority data type can indicate an importance of the aerial vehicle in comparison to the one or more aerial vehicles in communication with the aerial vehicle. For example, aerial vehicles of a higher importance (e.g., higher priority) can be deferred to when determining updated routes. For example, a first aerial vehicle can be a medical aerial vehicle (e.g., a helicopter carrying a patient). In such an example, the first aerial vehicle can reject requests to perform a cooperative maneuver based on the priority of first aerial vehicle in transporting the patient. In such an example, the other aerial vehicles can perform cooperative maneuvers to avoid the first aerial vehicle.

The targetAircraftList data type can include a list of aerial vehicles in communication with an aerial vehicle (e.g., the aerial vehicles which have received a request to perform cooperative maneuvers). In such an example, aerial vehicles can be added or removed from the list of aerial vehicles based on whether the aerial vehicles are within range of the aerial vehicle. In some examples, the list of aerial vehicles from a message of a first aerial vehicle and the response of the second aerial vehicle can differ based on whether the first aerial vehicle and the second aerial vehicle have communicated with the same aerial vehicles.

The lifeTime data type can represent an amount of time for the request to perform cooperative maneuvers to be valid. For example, when the amount of time exceeds a predetermined threshold, aerial vehicles can ignore or reject a request to perform cooperative actions.

An example data structure for a response (e.g., a message including the rsps of the intReqRsp data type) is included below.

```
DriveResponse::= SEQUENCE {
  rspID INTEGER, -- local ID of this response,--
  request/response in serial
  IRR messages should keep the same rspID
  rspStatus Status,
  targetAircraftList AircraftIDList OPTIONAL,--
  the ID of target aircrafts
  lifeTime TimeOffset OPTIONAL,-- Lifetime of
  this response, calculated
  from secMark of this message
  rejectReason Reason OPTIONAL,
  }
```

The rspID data type can represent an integer counter identifying the response. In examples where multiple messages (e.g., multiple responses) are transmitted between the aerial vehicles, the rspID can be the same ID value for subsequent messages and responses associated with the response (e.g., the initial message responding to a request to perform cooperative maneuvers).

The rspStatus data type can indicate a status of the aerial vehicle transmitting the response, such as indicating whether the aerial vehicle cancels, accepts, or rejects a request to perform a cooperative maneuver. In another example, the rspStatus data type can further indicate whether the aerial vehicle is executing the cooperative maneuver and whether aerial vehicle confirms receipt of the message requesting the cooperative maneuver.

The rejectReason data type can indicate a reason the aerial vehicle transmitting the response rejects a request to perform a cooperative maneuver. In some examples, the aerial vehicle can reject a cooperative maneuver because the cooperative maneuver conflicts with a flying route of the aerial vehicle. For example, the aerial vehicle can reject the cooperative maneuver based on the cooperative measure not being safe for the aerial vehicle to perform. In such an example, an aerial vehicle can include various sensors to detect obstacles in the environment, such as buildings, trees, powerlines, etc. The aerial vehicle can reject a cooperative maneuver which can contradict safety protocols of the aerial vehicle. For example, an aerial vehicle can reject a message requesting cooperative maneuvers which can cause the aerial vehicle to travel close to obstacles (e.g., within a predetermined distance threshold).

In another example, the aerial vehicle can reject a cooperative based on the aerial vehicle having a malfunction. In a further example, the aerial vehicle can reject a cooperative maneuver based on the aerial vehicle being a higher priority aerial vehicle than the aerial vehicle transmitting the message including the request. In another example, the aerial vehicle can reject the cooperative maneuver based on the aerial vehicle having a conflicting cooperative maneuver received from a higher priority aerial vehicle.

In some aspects, the AircraftIntentionRequestResponse can include aircraftAddInfo data type indicating information associated with the aerial vehicle transmitting the message or response. For example, the aircraftAddInfo can indicate whether the aerial vehicle is a UAV, manned, delivering goods, a medical transport, etc.

In further aspects, the AircraftIntentionRequestResponse can include a source data type indicating information associated with how the aerial vehicle determines the route and cooperative maneuvers of the aerial vehicle. For example, where the aerial vehicle is a manned aerial vehicle, an operator can input the route of the aerial vehicle and can perform cooperative maneuvers. In other examples, the source data type can indicate that an aerial vehicle is autonomous, semi-autonomous, or remotely piloted.

In some examples, aerial vehicles can transmit multiple messages and multiple responses to determine cooperative maneuvers to perform. For example, an aerial vehicle can transmit a first message and based on a response from another aerial vehicle, the aerial vehicle can transmit an updated message including updated location data and updated route data. The updated message can include steering data indicating an intended piloting operation to perform the cooperative maneuver. The aerial vehicle can receive an updated response from another aerial vehicle indicating an updated route (e.g., updated route data) of another aerial vehicle.

Various aspects of the present disclosure will be described with respect to the figures.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), a network-connected wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, connected units, and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

In some examples, a connected unit may be a device that can transmit and receive messages over a communications link or interface (e.g., a cellular-based sidelink or PC5 interface, an 802.11 or WiFi™ based Dedicated Short Range Communication (DSRC) interface, and/or other interface(s), etc.) to and from one or more UEs, other connected units, and/or base stations. An example of messages that can be transmitted and received by a connected unit includes aircraft-to-everything (A2X) messages, which are further described below.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

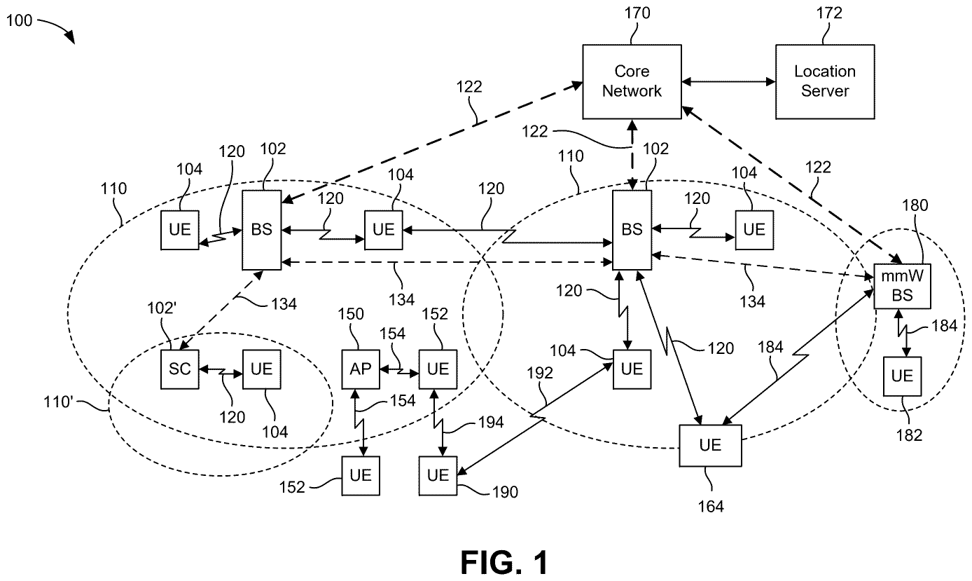

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs (e.g., including AP 150), etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

As described above, wireless communications systems support communication among multiple UEs. In various examples, wireless communications systems may be configured to support device-to-device (D2D) communication and/or aircraft-to-everything (A2X) communication. A2X communications may be performed using any radio access technology, such as LTE, 5G, WLAN, or other communication protocol. In some examples, UEs may transmit and receive A2X messages to and from other aerial UEs, and/or other non-aerial UEs (e.g., terrestrial UEs, vehicle UEs, etc.), connected units, and/or other devices over a direct communications link or interface (e.g., a PC5 or sidelink interface, an 802.11p DSRC interface, and/or other communications interface) and/or via a network. The communications may be performed using resources assigned by the network (e.g., an eNB, gNB, base station, and/or other network device), resources pre-configured for A2X use, and/or using resources determined by the UEs.

A2X communications may include communications between aerial UEs, aircrafts, aerial or airborne vehicles, connected aircrafts, etc., (e.g., aircraft-to-aircraft (A2A), communications between aerial UEs and infrastructure (e.g., aircraft-to-infrastructure (A2I)), communications between aerial UEs and pedestrians (e.g., aircraft-to-pedestrian (A2P)), and/or communications between aerial UEs and network servers (aircraft-to-network (A2N)). In some examples of A2X communications, data packets may be sent directly (e.g., using a PC5 interface, using an 802.11 DSRC interface, etc.) between aerial UEs without going through the network, eNB, or gNB. A2X-enabled aircraft, for instance, may use a short-range direct-communication mode that provides 360° non line-of-sight (NLOS) awareness, complementing onboard line-of-sight (LOS) sensors, such as cameras, radio detection and ranging (RADAR), Light Detection and Ranging (LIDAR), among other sensors. In some examples, the combination of wireless technology and onboard sensors enables A2X vehicles to observe and/or anticipate potential hazards, obstacles, collision risks, flight path planning issues, etc. A2X aircraft may also understand alerts or notifications from other A2X-enabled aircrafts (e.g., based on A2X and/or A2A communications, etc.), from infrastructure systems (e.g., based on A2I communications), and/or from user devices (e.g., based on A2P communications).

In some examples, sidelink communications may be performed according to 3GPP communication protocols sidelink (e.g., using a PC5 sidelink interface according to LTE, 5G, etc.), Wi-Fi direct communication protocols (e.g., DSRC protocol), or using any other device-to-device communication protocol. In some examples, sidelink communication may be performed using one or more Unlicensed National Information Infrastructure (U-NII) bands. For instance, sidelink communications may be performed in bands corresponding to the U-NII-4 band (5.850-5.925 GHZ), the U-NII-5 band (5.925-6.425 GHz), the U-NII-6 band (6.425-6.525 GHZ), the U-NII-7 band (6.525-6.875 GHz), the U-NII-8 band (6.875-7.125 GHZ), or any other frequency band that may be suitable for performing sidelink communications.

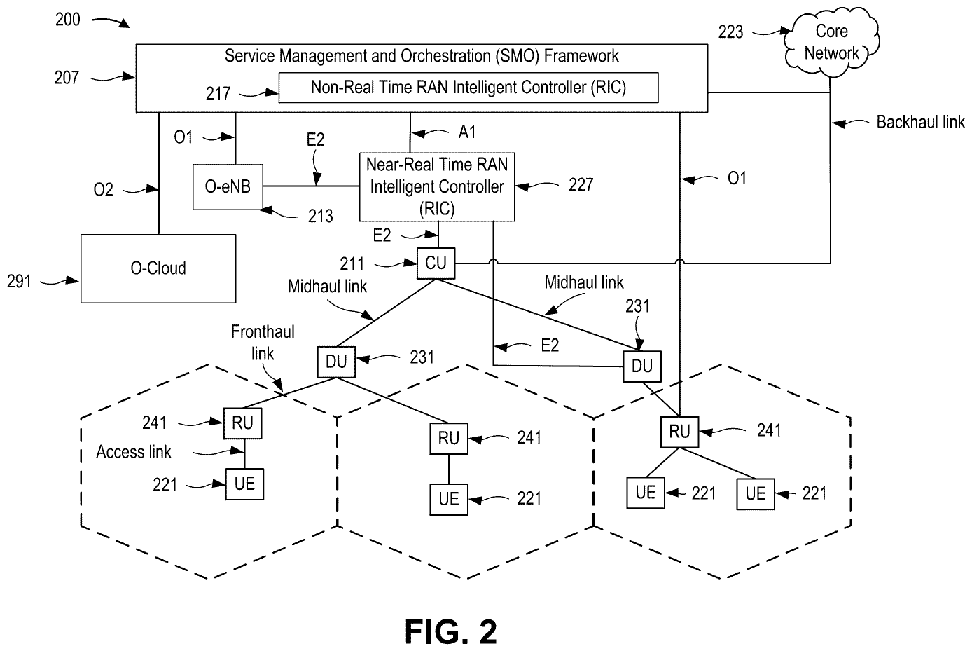

FIG. 2 is a diagram illustrating an example of a disaggregated base station architecture, which may be employed by an A2X communications system and/or an A2X-capable communications system, etc., in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 200 architecture. The disaggregated base station 200 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) such as DU 231 via respective midhaul links, such as an F1 interface. The DUs (including DU 231) can communicate with one or more radio units (RUs) 241 via respective fronthaul links. The RUs 241 may communicate with respective UEs (e.g., UE 221) via one or more RF access links. In some implementations, multiple RUs 241 may simultaneously serve the UE 221.

Each of the units, e.g., the CUS (e.g., CU 211 and other CUs), the Dus (e.g., including DU 231), the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (e.g., Central Unit-User Plane (CU-UP)), control plane functionality (e.g., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 231, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

One or more RUs 241 can implement lower-layer functionality. In some deployments, an RU (e.g., an RU from RUs 241), controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a server-based (e.g., cloud-based) RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs (including CU 211), DUs (including DU 231), RUs 241 and Near-RT RICs 227. In some implementations, the SMO Framework 207 can communicate with a hardware aspect of a 4G RAN, such as an open eNB (O-eNB) 213, via an O1 interface. Additionally, in some implementations, the SMO Framework 207 can communicate directly with one or more RUs 241 via an O1 interface. The SMO Framework 207 also may include a non-RT RIC 217 configured to support functionality of the SMO Framework 207.

The non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs (e.g., CU 211), one or more DUs (e.g., DU 231), or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the non-RT RIC 217 or the Near-RT RIC 227 may be configured to tune RAN behavior or performance. For example, the non-RT RIC 217 may monitor long-term trends and patterns for performance and employ AI/ML models to perform corrective actions through the SMO Framework 207 (such as reconfiguration via 01) or via creation of RAN management policies (such as A1 policies).

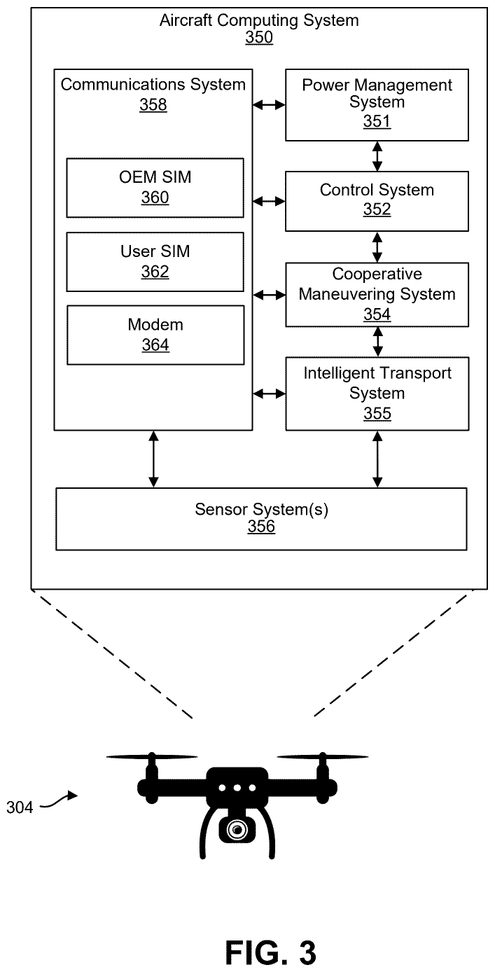

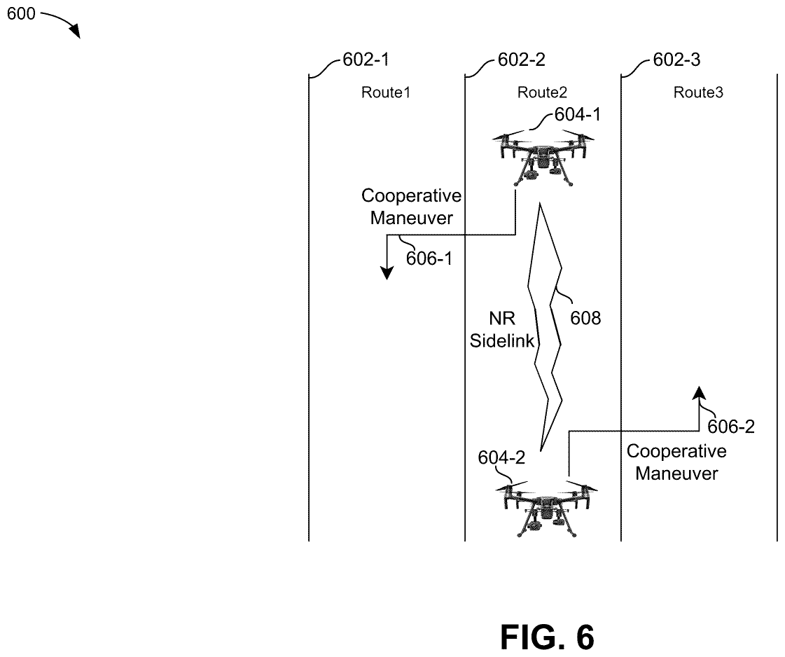

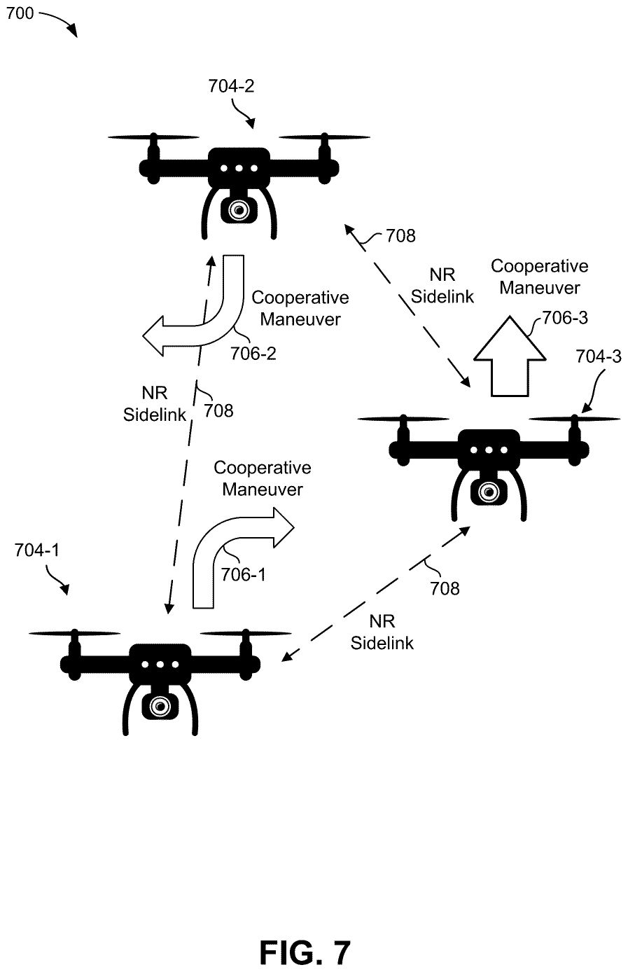

FIG. 3 is a block diagram illustrating an example of a computing system 350 of an aerial UE (e.g., connected aircraft, etc.) 304. In some cases, the aerial UE 304 of FIG. 3 may be the same as or similar to one or more of the aerial vehicles of FIG. 6, and the aerial vehicles of FIG. 7.

The aerial UE 304 is an example of a UE that can communicate with a network (e.g., an eNB, a gNB, a positioning beacon, a location measurement unit, and/or other network entity) over one or more interfaces for wireless communications. The aerial UE 304 is also an example of a UE that can communicate with other aerial UEs using A2X communications over a PC5 interface (e.g., or another device to device direct interface, such as a DSRC interface, etc.). As shown, the aircraft computing system 350 can include at least a power management system 351, a control system 352, a cooperative maneuvering system 354, an intelligent transport system (ITS) 355, one or more sensor systems 356, and a communications system 358. In some cases, the aircraft computing system 350 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 352 can be configured to control one or more operations of the aerial UE 304, the power management system 351, the computing system 350, the cooperative maneuvering system 354, the ITS 355, and/or one or more other systems of the aerial UE 304 (e.g., a flight planning system, an obstacle detection and/or collision avoidance system, a safety system other than the ITS 355, a cabin system, and/or other system(s), etc.). In some examples, the control system 352 can include one or more electronic control units (ECUs). An ECU can control one or more of the electrical systems or subsystems in an aerial UE (e.g., a drone, UAV, UAS, etc.). Examples of specific ECUs that can be included as part of the control system 352 include a flight control module (FCM), a propulsion control module (PCM), a gimbal control module, a navigation and positioning control module, a payload control module, etc., among various others. In some cases, the control system 352 can receive sensor signals from the one or more sensor systems 356 and can communicate with other systems of the aircraft computing system 350 to operate the aerial UE 304.

The aircraft computing system 350 also includes a power management system 351. In some implementations, the power management system 351 can include a power management integrated circuit (PMIC), a standby battery, and/or other components. In some cases, other systems of the aircraft computing system 350 can include one or more PMICs, batteries, and/or other components. The power management system 351 can perform power management functions for the aerial UE 304, such as managing a power supply for the computing system 350 and/or other components of the aerial UE 304 (e.g., including a propulsion or lift system of the aerial UE 304, the sensor system(s) 356 of the aerial UE 304, etc.). For example, the power management system 351 can provide a stable power supply in view of power fluctuations, such as based on a startup current of the propulsion system, temperature or weather-based power fluctuations and/or battery supply fluctuations, etc. In another example, the power management system 351 can perform thermal monitoring operations, such as by checking ambient and/or transistor junction temperatures. In another example, the power management system 351 can perform certain functions based on detecting a certain temperature level, such as causing a cooling system to cool certain components of the aircraft computing system 350 (e.g., the control system 352, such as one or more ECUs), shutting down certain functionalities of the aircraft computing system 350, among other functions.

The aircraft computing system 350 can further include a communications system 358. The communications system 358 can include both software and hardware components for transmitting signals to and receiving signals from a network (e.g., a gNB or other network entity) and/or from other UEs (e.g., to another aircraft or aerial UE over a PC5 interface, WiFi interface (e.g., DSRC), Bluetooth™ interface, and/or other wireless and/or wired interface). For example, the communications system 358 can be configured to transmit and receive information wirelessly over any suitable wireless network (e.g., a 3G network, 3G network, 5G network, WiFi network, Bluetooth™ network, and/or other network). The communications system 358 may include various components or devices used to perform the wireless communication functionalities, including an original equipment manufacturer (OEM) subscriber identity module (referred to as a SIM or SIM card) 360, a user SIM 362, and a modem 364. While the aircraft computing system 350 is shown as having two SIMs and one modem, the aircraft computing system 350 can have any number of SIMs (e.g., zero SIMs, one SIM or more than two SIMs) and any number of modems (e.g., one modem, two modems, or more than two modems) in some implementations.

The user SIM 362 can be used by the communications system 358 for performing wireless network access functions in order to support a user data connection (e.g., for conducting phone calls, messaging, Infotainment related services, among others). In some cases, a user device of a user can connect with the aircraft computing system 350 over an interface (e.g., over PC5, Bluetooth™, WiFi™ (e.g., DSRC), a universal serial bus (USB) port, and/or other wireless or wired interface). Once connected, the user device can transfer wireless network access functionality from the user device to communications system 358 of the aerial UE 304, in which case the user device can cease performance of the wireless network access functionality (e.g., during the period in which the communications system 358 is performing the wireless access functionality). The communications system 358 can begin interacting with a base station to perform one or more wireless communication operations, such as facilitating a phone call, transmitting and/or receiving data (e.g., messaging, video, audio, etc.), among other operations. In such cases, other components of the aircraft computing system 350 can be used to output data received by the communications system 358. For example, the aircraft computing system 350 can display video received by the communications system 358 on one or more displays and/or can output audio received by the communications system 358 using one or more speakers.

A modem is a device that modulates one or more carrier wave signals to encode digital information for transmission and demodulates signals to decode the transmitted information. The modem 364 (and/or one or more other modems of the communications system 358) can be used for communication of data for the OEM SIM 360 and/or the user SIM 362. In some examples, the modem 364 can include a 3G (or LTE) modem and another modem (not shown) of the communications system 358 can include a 5G (or NR) modem. In some examples, the communications system 358 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 364 (and/or one or more other modems of the communications system 358) can be used for performing A2X communications (e.g., with other aerial UEs for A2X communications, with other devices for A2X communications comprising A2D communications, with infrastructure systems for A2X communications comprising A2I communications, etc.). In some examples, the communications system 358 can include an A2X modem used for performing A2X communications (e.g., sidelink communications over a PC5 interface), in which case the A2X modem can be separate from one or more modems used for wireless network access functions (e.g., for network communications over a network/interface and/or sidelink communications other than A2X communications).

In some examples, the communications system 358 can be or can include a telematics control unit (TCU). In some implementations, the TCU can include a network access device (NAD) (also referred to in some cases as a network control unit or NCU). The NAD can include the modem 364, any other modem not shown in FIG. 3, the OEM SIM 360, the user SIM 362, and/or other components used for wireless communications. In some examples, the communications system 358 can include a Global Navigation Satellite System (GNSS). In some cases, the GNSS can be part of the one or more sensor systems 356, as described below. The GNSS can provide the ability for the aircraft computing system 350 to perform one or more location services, navigation services, and/or other services that can utilize GNSS functionality.

In some cases, the communications system 358 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, and/or other wired interface) for performing communications over one or more hardwired connections, and/or other components that can allow the aerial UE 304 to communicate with a network and/or other UEs.

The aircraft computing system 350 further includes one or more sensor systems 356 (e.g., a first sensor system through an Nth sensor system, where N is a value equal to or greater than 0). When including multiple sensor systems, the sensor system(s) 356 can include different types of sensor systems that can be arranged on or in different parts of the aerial UE 304. The sensor system(s) 356 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 350 of the aerial UE 304.

While the aircraft computing system 350 is shown to include certain components and/or systems, one of ordinary skill will appreciate that the aircraft computing system 350 can include more or fewer components than those shown in FIG. 3. For example, the aircraft computing system 350 can also include one or more input devices and one or more output devices (not shown). In some implementations, the aircraft computing system 350 can also include (e.g., as part of or separate from the control system 352, the cooperative maneuvering system 354, the communications system 358, and/or the sensor system(s) 356) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

The aircraft computing system 350 can also include a cooperative maneuvering system 354. In some examples, the cooperative maneuvering system 354 can include an application using information from a detect and avoid system to detect obstacles in an environment. For example, the cooperative maneuvering system 354 can be used to implement one or more DAA algorithms that can be used to detect potential obstacles, hazards, and/or conflicting aerial traffic in the nearby or surrounding environment of the aerial UE 304. The cooperative maneuvering system 354 can communicate piloting operations or actions which when performed can provide obstacle avoidance. For example, the obstacles can be other UEs operating in an airspace. In such an example, the cooperative maneuvers can include intended piloting operations (e.g., piloting operations to be performed or performable) by the UE transmitting a message requesting cooperative maneuvers and operations performable by the UE. In some examples, the UE receiving the message requesting cooperative maneuvers can determine cooperative maneuvers based on the maneuvers of the UE transmitting the message and can respond with a message indicating cooperative measures to be performed by the UE (e.g., the UE responding to the message). In some examples, the cooperative maneuvering system 354 can perform the detection based at least in part on using one or more sensor inputs obtained from the sensor system(s) 356 of the aerial UE 304. In some examples, the cooperative maneuvering system 354 can detect the potential obstacles, hazards, and/or conflicting aerial traffic, and may implement one or more maneuvers or updates to a path planning system to avoid collisions with the detected obstacles. In some aspects, the cooperative maneuvering system 354 can use the sensor system(s) 356 to perform obstacle detection and may subsequently perform tracking and/or identification of detected obstacles over time. For example, the cooperative maneuvering system 354 can be configured to track the position, speed, altitude, heading, and/or trajectory of detected objects. In some cases, detected objects may be static or stationary (e.g., buildings, cellular towers, radio towers, bridges, power lines, etc.) or mobile (e.g., other drones, UAVs, aerial UEs, airplanes, birds, etc.). In some cases, the cooperative maneuvering system 354 can communicate with other aerial UEs to adjust the routes of the aerial UEs to avoid other aerial UEs. For example, the cooperative maneuvering system 354 can use one or more DAA algorithms implemented by a DAA system to determine whether another aerial UE is on a collision course with the aerial UE 304 (e.g., is on a projected course that comes within a configured threshold distance from the aerial UE 304.). The cooperative maneuvering system 354 can use the determination of the DAA system to determine piloting operations and can transmit a message to another aerial UV requesting performance of cooperative maneuvers. In some examples, the cooperative maneuvering system 354 can communicate with a flight planning module of the aerial UE 304 (e.g., where the flight planning module may be included within and/or implemented by the control system 352, etc.) to update a path or route of the aerial UE 304 dynamically and in real-time to avoid obstacles. For example, the cooperative maneuvering system 354 can be a safety application application which can be used to generate messages to other aerial UEs requesting the other aerial UEs perform piloting operations. The cooperative maneuvering system 354 can be used to perform piloting operations (e.g., by communicating with the control system 352) based on responses from other aerial UEs to the messages.

In some examples, the aircraft computing system 350 can include the intelligent transport system (ITS) 355. In some examples, the ITS 355 can be used for implementing A2X communications. For example, an ITS stack of the ITS 355 can generate A2X messages based on information from an application layer of the ITS. In some cases, the application layer can determine whether certain conditions have been met for generating messages for use by the ITS 355 and/or for generating messages that are to be sent to other aerial UEs for A2X communications, etc. In some cases, the communications system 358 and/or the ITS 355 can obtain aircraft kinematics information (e.g., from other components of the aerial UE 304 via one or more corresponding buses). In some examples, the communications system 358 can obtain the aircraft kinematics information via one or more corresponding buses implemented by the aerial UE 304 and can send the aircraft kinematics information to a PHY/MAC layer of the ITS 355. The ITS 355 can provide the aircraft kinematics information to the ITS stack of the ITS 355. The aircraft kinematics information can include aircraft related information, such as a heading of the aerial UE 304, a speed of the aerial UE 304, acceleration or deceleration information of the aerial UE 304, path planning information of the aerial UE 304, obstacle detection and/or collision avoidance information of the aerial UE 304, altitude or height information of the aerial UE 304, etc., among other information. The aircraft kinematics information can be continuously or periodically (e.g., every 1 millisecond (ms), every 10 ms, or the like) provided to the ITS 355.

A security layer of the ITS 355 can be used to securely sign messages from the ITS stack that are sent to and verified by other aerial UEs configured for A2X communications, such as other aerial UEs, connected aircraft, and/or A2X-capable devices, etc. The security layer can also verify messages received from such other UEs. In some implementations, the signing and verification processes can be based on a security context of the aerial UE 304. In some examples, the security context may include one or more encryption-decryption algorithms, a public and/or private key used to generate a signature using an encryption-decryption algorithm, and/or other information. For example, each ITS message generated by the ITS 355 can be signed by the security layer of the ITS 355. The signature can be derived using a public key and an encryption-decryption algorithm. An aerial UE or other A2X-capable wireless device receiving a signed message can verify the signature to make sure the message is from an authorized aerial UE. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 355 can determine certain operations (e.g., A2X-based operations) to perform based on messages received from other UEs. The operations can include safety-related and/or other operations, such as operations for air traffic management, traffic deconfliction, traffic or access prioritization, access control and/or restriction, zone-based policy adjustment or configuration, etc. In some cases, A2X messaging information can be used by multiple aerial UEs to implement respective cooperative maneuvering operations. For example, two aerial UEs on a direct collision course with one another can use A2X messages to negotiate (a back and forth transmission of messages and responses indicating intended piloting operations to be performed) a change in routes of the two aerial UEs. The UEs can update their respective flight paths away from the collision course (and, in some cases, away from the updated flight path of the other aerial UE after its own collision avoidance maneuver is performed) based on the negotiations. For example, the first aerial UE may request to deviate in a lateral direction such as to the left while the second aerial UE deviates in a lateral direction to the right. The second aerial UE can agree to the request and operate according to the request. In another example, the first aerial UE may request to deviate upwards while the second aerial UE deviates downwards, etc. In some examples, the first aerial UE can transmit a message indicating the direction which the first aerial UE intends to travel. The second aerial UE can receive the message and determine an updated route based on the message. The second aerial UE can transmit a response to the message indicating an agreement to the cooperative maneuver and an updated route of the second aerial UE. The first aerial UE can confirm the second aerial UE response and the first aerial UE, and the second aerial UE can operate based on the exchanged messages and responses.

In one illustrative example, a message can be received by the communications system 358 from another aerial UE 304 (e.g., over an NR sidelink interface, PC5 interface, a DSRC interface, or other device to device direct interface) indicating that position, trajectory, and/or other aircraft kinematics information of the other aerial UE. In response to receiving the message, the ITS stack can generate a message or instruction and can send the message or instruction to the control system 352 and/or the cooperative maneuvering system 354, which can cause the control system 352 and/or cooperative maneuvering system 354 to automatically perform collision avoidance based on communications with other aerial UEs.

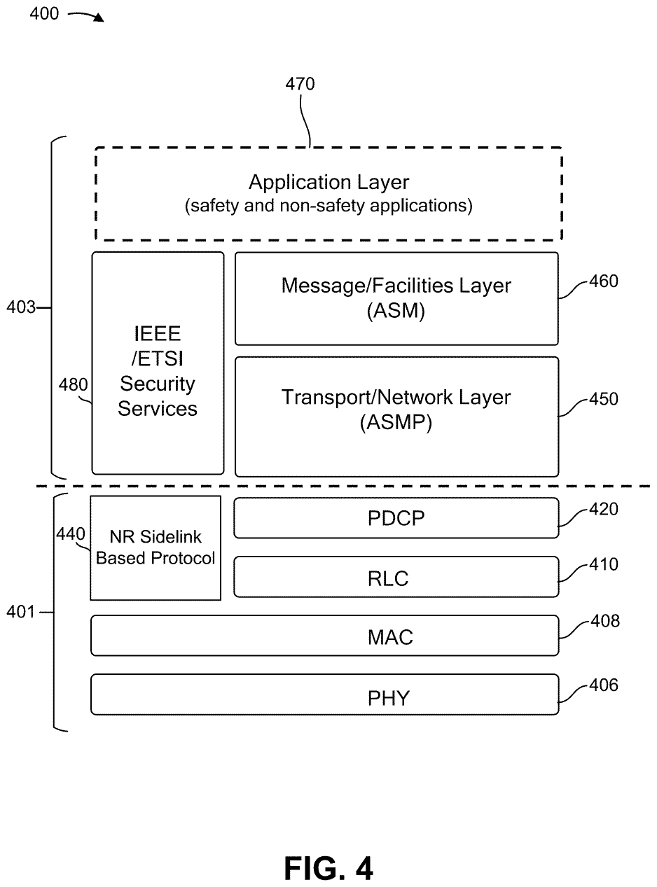

FIG. 4 is a diagram illustrating an example system stack 400 of an aircraft-to-everything (A2X) communication system, in accordance with some examples. In some aspects, the A2X system stack 400 can include one or more lower layers (e.g., also referred to herein as a lower layer 401 portion and/or a lower layer 401), and one or more upper layers 403 (e.g., also referred to herein as a higher layer portion and/or a higher layer).

In one illustrative example, the lower layer 401 portion of the A2X system stack 400 can be implemented based on the 3GPP-based PC5 protocol. For example, in some aspects, the lower layer 401 portion can utilize an NR sidelink-based protocol, represented in the A2X system stack 400 as the NR sidelink-based protocol 440, which can be configured to provide sidelink communications utilizing NR based wireless signals transmitted between respective NR sidelink interfaces of each aerial UE. In some non-limiting examples, the lower layer 401 portion of the A2X system stack 400 can utilize the 3GPP Release 14 and/or Release 15 LTE-based PC5 protocol, including the physical resource pool design, resource allocation and scheduling, and/or congestion control. In other examples, the lower layer 401 portion can use NR sidelink based protocols.

In some aspects, the lower layer 401 portion of the A2X system stack 400 can also be referred to as an LTE-A2X access layer, and can include a Packet Data Convergence Protocol (PDCP) layer 420, a Radio Link Control (RLC) layer 410, a media access control (MAC) layer 408, and a Physical (PHY) layer 406.

The upper layer 403 portion of the A2X system stack 400 can include a transport/network layer 450, which can be used to implement a connectionless, non-IP protocol referred herein as Aerial Short Message Protocol (ASMP), which may correspond to or be based upon a lightweight version of UDP. The upper layer 403 portion can further include a messages/facilities layer 460, which can be utilized with the application layer 470 for the exchange of Aerial Safety Messages (ASMs) between the various aerial UEs participating in or otherwise associated with the A2X communication network utilizing the A2X system stack 400, etc. In the application layer 470 (e.g., which can correspond to and/or include safety application and non-safety applications), the longitude, latitude, altitude, speed, heading, etc., dynamics or kinematics information of a respective aerial UE can be packed together to form (e.g., generate) the ASM for the respective aerial UE. The ASM for the respective aerial UE can be based on the dynamics or kinematics information of the respective aerial UE, passed from the application layer 470 to the message/facilities layer 460, which packs the information into the ASM. The ASM can be passed from the message/facilities layer 460 to the transport/network layer 450, which can operate with the lower layer 401 portion of the A2X system stack 400 to provide the PC5-based transmission of the ASM from the respective aerial UE to one or more nearby aerial UEs. The randomized L2 ID of the respective aerial UE can be associated with lower-layer or lower-level L2 functionalities of the A2X system stack 400.

In some aspects, the application layer 470 can be used to generate and broadcast cooperative maneuvering messages and responses. For example, the cooperative maneuvering operations can be performed using an application of the application layer 470. In such an example, the application can be used to determine piloting operations to be performed by an aerial UE based on responses to requests to perform cooperative maneuvers.

In some aspects, the upper layer 403 portion of the A2X system stack 400 can include a security services layer 480, which may be implemented as IEEE/ETSI security services. In some cases, IEEE 1609.2 security certificates can be used for authorization purposes between the aerial UEs and/or for the ASMs transmitted between the aerial UEs on the A2X network.

In the application layer 470, each aerial UE can be configured to broadcast its own respective beacon message (e.g., the ASM message) periodically, where the respective beacon (e.g., ASM) message for each aerial UE is indicative of the current or most recent longitude, latitude, altitude, speed, heading, etc., information for the aerial UE. Each aerial UE can receive the beacon (e.g., ASM) messages broadcast by any or all surrounding (e.g., nearby, within communication range of the PC5 sidelink, etc.) aerial UEs. Aerial UEs can be configured to extract the respective dynamics or kinematics information of nearby aerial UEs from the respective beacons (e.g., ASM messages) received from each nearby aerial UE, and provide the extracted longitude, latitude, altitude, speed, heading, etc. . . . , information for each nearby aerial UE to its own internal DAA algorithm(s) (e.g., corresponding to the cooperative maneuvering system 354 of the aircraft computing system 350 implemented by the aerial UE 304 of FIG. 3, etc.) to perform DAA and/or collision avoidance according to the beacon/ASM information of the surrounding (e.g., neighboring) aerial UEs communicating via the A2X system stack 400.

As noted above, the lower layer 401 portion of the A2X system stack 400 can also be referred to as an access layer and/or an LTE-A2X access layer, and may include the PDCP layer 420, the RLC layer 410, the MAC layer 408, and the PHY layer 406. In some examples, the lower layer 401 (e.g., access layer) of the A2X system stack 400 can implement access layer autonomous resource selection for the aerial UEs to each select and/or utilize different time-frequency resources. For example, multiple aerial UEs cannot use the same time-frequency resource(s) without collision of their respective A2X messages and/or ASM beacon broadcasts, and the access layer (e.g., the lower layer 401) can implement autonomous resource selection to prevent such collisions.

In some cases, an aerial UE can be configured with and/or can determine a target latency requirement for its ASM messages or other A2X transmissions. The target latency requirement can be a time value (e.g., length or duration of time) that represents a latency threshold for the aerial UE. To perform access layer autonomous resource selection, the aerial UE can be configured to listen and monitor (e.g., determine) resource usage information for the set of time-frequency resources allocated or available for A2X, over a previous time period with a length equal to the target latency requirement of the aerial UE. For example, an aerial UE with a target latency requirement of 20 millisecond (ms) can perform autonomous resource selection based on monitoring the resource usage of the time-frequency resource grid over a 20 ms window. The resource usage information determined based on the aerial UE monitoring for the 20 ms window given by its latency requirement can subsequently be used by the aerial UE to predict channel conditions (e.g., resource usage) for the next time window having the same length (e.g., 20 ms, based on the target latency requirement of the aerial UE).

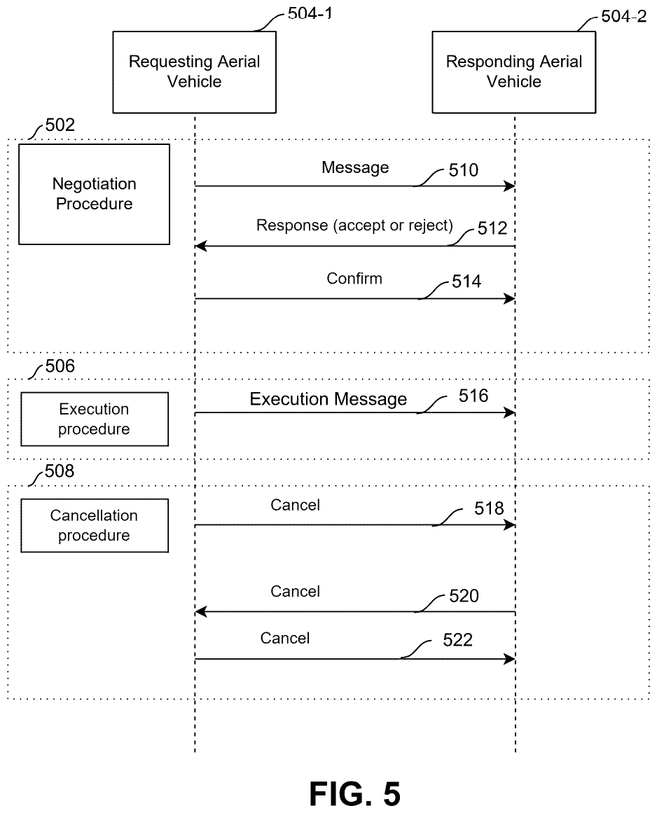

FIG. 5 is a diagram illustrating a call flow diagram of a process for wireless communication between a first aerial vehicle requesting performance of cooperative maneuvers (e.g., requesting aerial vehicle 504-1) and a second aerial vehicle responding to the request (e.g., responding aerial vehicle 504-2). Messages and responses of the process 500 can be generated and transmitted by the requesting aerial vehicle 504-1 and the responding aerial vehicle 504-2.

FIG. 5 illustrates communication between two aerial vehicles, the requesting aerial vehicle 504-1 and the responding aerial vehicle 504-2. The requesting aerial vehicle 504-1 and the responding aerial vehicle 504-2 can be part of a network of aerial vehicles. In such an example, the requesting aerial vehicle 504-1 can be a requesting aerial vehicle (e.g., aerial vehicle requesting cooperative maneuvers) to the second aerial vehicle and a responding aerial vehicle to another aerial vehicle.

The process 500 can include a negotiation procedure 502. The negotiation procedure can be handshake procedure in which the requesting aerial vehicle 504-1 and the responding aerial vehicle 504-2 acknowledge the other aerial vehicle and negotiate cooperative maneuvers to be performed by the requesting aerial vehicle 504-1 and the responding aerial vehicle 504-2.

By way of a non-limiting example, the negotiation procedure 502 can include transmitting a message 510 including a request to perform a cooperative maneuver from the requesting aerial vehicle 504-1 to the responding aerial vehicle 504-2. In some examples, the responding aerial vehicle 504-2 can be a plurality of aerial vehicles. For example, the requesting aerial vehicle 504-1 can transmit (or broadcast) the message 510 to a plurality of aerial vehicles.

The message 510 transmitted by the requesting aerial vehicle 504-1 can include information associated with the requesting aerial vehicle 504-1 such as location data representing a location of the requesting aerial vehicle 504-1 and route data representing an intended route of the requesting aerial vehicle 504-1. The message can include the previously described AircraftIntentionRequestResponse message requesting cooperative maneuvers.

The responding aerial vehicle 504-2 can receive the message 510 and generate a response 512 (e.g., a message in response to the message 510) accepting or rejecting the cooperative maneuver of the message 510. For example, the route data of the message 510 can represent an intended route of the requesting aerial vehicle 504-1. The responding aerial vehicle 504-2 can accept or reject the intended route of the requesting aerial vehicle 504-1 based on whether the intended route conflicts with a route of the responding aerial vehicle 504-2.

In some examples, the responding aerial vehicle 504-2 can transmit a response 512 including an intended route of the responding aerial vehicle 504-2. In such an example, the intended route of the responding aerial vehicle 504-2 can be a route adjusted based on the route data of the message 510. In further examples, the response 512 can use the same format of messaging as the message 510. For example, the response 512 can include the previously described AircraftIntentionRequestResponse message.

The process 500 illustrates a single message and single response. In some examples, the requesting aerial vehicle 504-1 and the responding aerial vehicle 504-2 can perform multiple rounds of the negotiation procedure before the cooperative maneuvers described in the message 510 and the response 512 are agreed upon and confirmed. The process 500 can include transmitting a confirmation message 514 from the requesting aerial vehicle 504-1 to the responding aerial vehicle 504-2 based on the responding aerial vehicle 504-2 accepting the cooperative maneuvers of the message 510. In some examples, the confirmation message 514 can be an updated message including updated location data and updated route data of the requesting aerial vehicle 504-1.

The process 500 can include an execution procedure 506. The execution procedure can include a periodic transmission of messages (e.g., execution message 516) from the requesting aerial vehicle 504-1 to the responding aerial vehicle 504-2 indicating performance of the cooperative maneuvers. For example, the execution messages 516 transmitted by the requesting aerial vehicle can be an updated message of the message 510 the responding aerial vehicle 504-2 accepted with updated location data and updated route data based on the performance of the cooperative maneuvers. In some examples, the responding aerial vehicle 504-2 can periodically transmit responses indicating updated location data and route data of the responding aerial vehicle 504-2.

The process 500 can include a cancellation procedure 508. The cancellation procedure 508 can begin based on a cancellation request 518 from the requesting aerial vehicle 504-1 or a cancellation request 520 from the responding aerial vehicle 504-2. In some examples, the cancellation procedure 508 can be triggered based on one of the aerial vehicles detecting an obstacle within an agreed upon route of one of the aerial vehicles. In another example, the cancellation procedure 508 can be triggered based on another aerial vehicle communicating with one of the requesting aerial vehicle 504-1 or responding aerial vehicle 504-2 indicating a route in conflict with one of the agreed upon routes from the negotiation procedure 502. In another example, the requesting aerial vehicle 504-1 can transmit a cancellation request 522 in response to a cancellation request from the responding aerial vehicle 504-2.

The process 500 can restart after either the requesting aerial vehicle 504-1 or the responding aerial vehicle 504-2 receive or transmit a cancellation request. For example, the requesting aerial vehicle 504-1 and the responding aerial vehicle 504-2 can renegotiate cooperative maneuvers after a cancellation request including the information causing the cancellation request to determine updated cooperative maneuvers. For example, an obstacle causing the cancellation can be considered by the requesting aerial vehicle 504-1 in determining updated route data. The requesting aerial vehicle 504-1 can transmit another message (e.g., an updated message) based on the updated location data and the updated route data to start a negotiation procedure 502. The responding aerial vehicle 504-2 can respond to the updated message with an updated response indicating updated location data and updated route data associated with the responding aerial vehicle 504-2.

FIG. 6 is a block diagram 600 illustrating an example of aerial vehicles (e.g., a first aerial vehicle 604-1 and a second aerial vehicle 604-2) communicating using an NR sidelink 608 to perform cooperative maneuver 606-1 and cooperative maneuver 606-2.

The block diagram 600 illustrates a first aerial vehicle 604-1 and a second aerial vehicle 604-2. The first aerial vehicle 604-1 and the second aerial vehicle 604-2 are illustrated as having accepted cooperative maneuvers of the other aerial vehicle using the call flow process further described in the description of FIG. 5. The first aerial vehicle 604-1 and the second aerial vehicle 604-2 can wirelessly communicate messages and responses using the NR sidelink 608.

In some aspects, the first aerial vehicle 604-1 and the second aerial vehicle 604-2 can include an aircraft computing system, such as the aircraft computing system 350. The first aerial vehicle 604-1 and the second aerial vehicle 604-2 can communicate using an NR sidelink-based protocol to communicate using the NR sidelink 608, such as the NR sidelink protocol 440 of the system stack 400 of FIG. 4.

The cooperative maneuver 606-1 can be performed by the first aerial vehicle 604-1 and the cooperative maneuver 606-2 can be performed by the second aerial vehicle 604-2. The cooperative maneuvers can adjust the routes of the first aerial vehicle 604-1 and the second aerial vehicle 604-2. For example, the cooperative maneuvers are illustrated as shifting the routes of the first aerial vehicle 604-1 and the second aerial vehicle 604-2 from a route 602-2 which may cause a collision between the aerial vehicles, to updated routes, such as route 602-1 for the first aerial vehicle 604-1 and route 602-3 for the second aerial vehicle 604-2.

FIG. 7 is a block diagram 700 illustrating another example of aerial vehicles (e.g., a first aerial vehicle 704-1, a second aerial vehicle 704-2, and a third aerial vehicle 704-3) communicating using an NR sidelink 708. By way of example, the block diagram 700 illustrates the first aerial vehicle 704-1, the second aerial vehicle 704-2, and the third aerial vehicle 704-3 in communication with one another and performing cooperative maneuvers based on the communication. In some examples, the aerial vehicles can communicate with one of the other aerial vehicles. In such an example, the first aerial vehicle 704-1 can communicate with the second aerial vehicle 704-2 and the third aerial vehicle 704-3. The second aerial vehicle 704-2 and the third aerial vehicle 704-3 can determine cooperative maneuvers based on the cooperative maneuvers of the first aerial vehicle 704-1.

The block diagram 700 illustrates each of the aerial vehicles performing cooperative maneuvers. For example, the first aerial vehicle 704-1 is illustrated as performing cooperative maneuver 706-1, the second aerial vehicle 704-2 is illustrated as performing cooperative maneuver 706-2, and the third aerial vehicle 704-3 is illustrated as performing cooperative maneuver 706-3. For example, cooperative maneuver 706-1 and cooperative maneuver 706-2 can include intended piloting operations to turn the respective aerial vehicles left or right to avoid the other aerial vehicle. In some examples, the cooperative maneuver can be to maintain a route. For example, the third aerial vehicle 704-3 is illustrated as having a route which does not overlap (e.g., is not determined to cause a collision) with the first aerial vehicle 704-1 and the second aerial vehicle 704-2. In such an example, the cooperative maneuver 706-3 of the third aerial vehicle 704-3 can be to maintain the route.

In other examples, the cooperative maneuvers can include piloting operations such as increasing speed of the aerial vehicles, decreasing speed of the aerial vehicles, increasing or decreasing altitude of the aerial vehicles, adjusting a heading of the aerial vehicles, hovering in place (e.g., stopping or stop and go), etc.

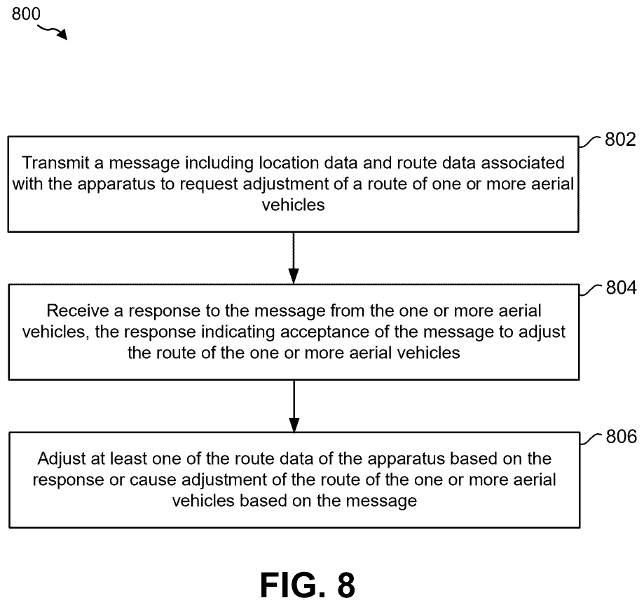

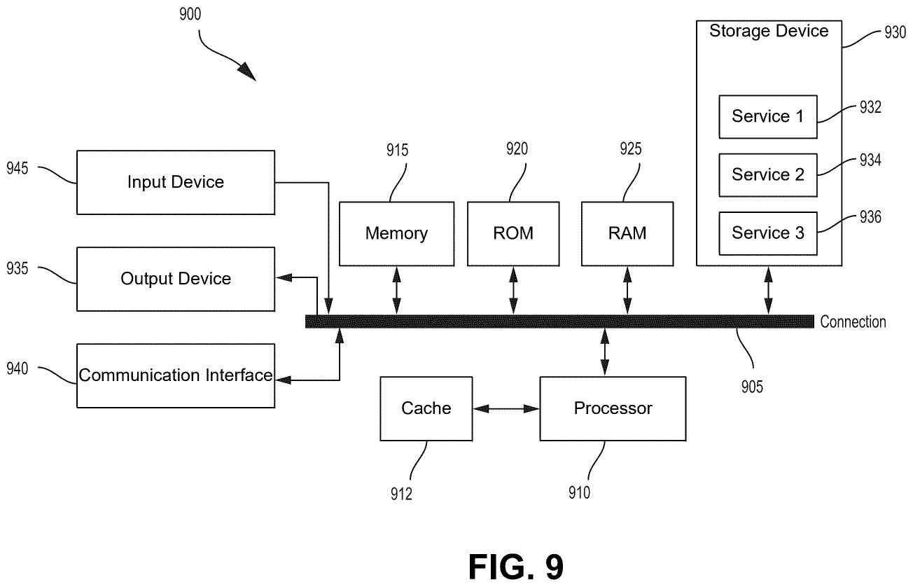

FIG. 8 is a flowchart diagram illustrating an example of a process 800 for performing wireless communications. In some examples, the process 800 can correspond to wireless communications comprising A2X messages, including an aerial short message (ASM) transmitted and/or received by one or more aerial UEs and/or non-aerial UEs. In some examples, the process 800 can be performed by an aerial UE, connected aircraft, and/or other UEs. In some cases, the process 800 can be performed by an aerial UE such as the aerial UE 304 of FIGS. 3, 604-1 and 604-2 of FIG. 6, 704-1, 704-2, and/or 704-3 of FIG. 7, etc. In some examples, the process 800 can be performed by a computing device or apparatus or a component or system (e.g., one or more chipsets, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 910 of FIG. 9 or other processor(s)).

At block 802, the apparatus (or component thereof) can transmit a message including location data and route data associated with the apparatus to request adjustment of a route of one or more aerial vehicles. In some examples, the aerial vehicle can be an unmanned aerial vehicle (UAV) such as a drone. In further examples, the apparatus is an aerial vehicle or a component of an aerial vehicle. The apparatus can be an unmanned aerial vehicle (UAV). In some examples the location data can include a latitude, a longitude, and an altitude of the apparatus.

In some aspects, the route data can include a sequence of waypoints over a predetermined period of time. In such aspects, each waypoint of the sequence of waypoints can indicate an expected latitude, an expected longitude, and an expected altitude of the apparatus. The expected latitude, the expected longitude, and the expected altitude of the apparatus can be associated with a point in time over the predetermined period of time. For example, the sequence of waypoints can represent intended positioning of the apparatus (e.g., the latitude, longitude, and altitude) when performing a route (e.g., traveling along the route). In some aspects, the route data can include a heading of the apparatus. The heading can include a horizontal angle of direction and a vertical angle of direction of the apparatus in traveling along the route. In further examples, the message can include a list of aerial vehicles from the one or more aerial vehicles that have accepted the message to request the adjustment of the route of the one or more aerial vehicles.

At block 804, the apparatus (or component thereof) can receive a response to the message from the one or more aerial vehicles, the response indicating acceptance of the message to adjust the route of the one or more aerial vehicles. In some aspects, the route of the one or more aerial vehicles can include information associated with the route of the one or more aerial vehicles. For example, the information associated with the route can include a starting location of the route, a target location of the route, and steering data indicating an intended piloting operation to be performed by the one or more aerial vehicles to travel along the route. In some examples, the piloting operation can include an indication of an action to be taken by the one or more aerial vehicles in traveling along a route, such as decreasing speed, increasing speed, stopping and hovering, steering in a lateral direction (e.g., left or right), etc. For example, the piloting operation can include at least one of an operation to maintain direction, an operation to adjust lateral direction, an operation to adjust altitude, an operation to decrease speed, or an operation to increase speed. In further examples, the route information can include a sequence of waypoints of the one or more aerial vehicles. In such an example, the sequence of waypoints can include latitude, longitude, and altitude of the one or more aerial vehicles over a period of time. In some aspects, the message or the response can include information associated with the apparatus of the one or more aerial vehicles. For example, the information can indicate whether the apparatus or the one or more aerial vehicles are manned, unmanned, or delivering goods.

At block 806, the apparatus (or component thereof) can adjust at least one of the route data of the apparatus based on the response or cause adjustment of the route of the one or more aerial vehicles based on the message. For example, the adjustment of the route can be represented as updated piloting operations (e.g., an adjustment in steering data of the one or more aerial vehicles). In some aspects, the apparatus (or component thereof) can transmit an updated message based on the acceptance of the message. In such an example, the updated message can indicate updated location data and updated route data associated with the apparatus. In another aspect, the apparatus (or component thereof) can receive an updated response to the updated message from the one or more aerial vehicles. In such an example, the updated response can indicate an updated route of the one or more aerial vehicles.

FIG. 9 illustrates an example computing device architecture 900 of an example computing device which can implement the various techniques described herein. In some examples, the computing device can include a mobile device, a wearable device, an extended reality (XR) device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 900 can implement the aircraft computing system 350 of FIG. 3 and/or various components thereof, etc. The components of computing device architecture 900 are shown in electrical communication with each other using connection 905, such as a bus. The example computing device architecture 900 includes a processing unit (CPU or processor) 910 and computing device connection 905 that couples various computing device components including computing device memory 915, such as read only memory (ROM) 920 and random-access memory (RAM) 925, to processor 910.

Computing device architecture 900 can include a cache of high-speed memory connected directly with, in close proximity to, or integrated as part of processor 910. Computing device architecture 900 can copy data from memory 915 and/or the storage device 930 to cache 912 for quick access by processor 910. In this way, the cache can provide a performance boost that avoids processor 910 delays while waiting for data. These and other engines can control or be configured to control processor 910 to perform various actions. Other computing device memory 915 may be available for use as well. Memory 915 can include multiple different types of memory with different performance characteristics. Processor 910 can include any general-purpose processor and a hardware or software service, such as service 1 932, service 2 934, and service 3 936 stored in storage device 930, configured to control processor 910 as well as a special-purpose processor where software instructions are incorporated into the processor design. Processor 910 may be a self-contained system, containing multiple cores or processors, a bus, memory controller, cache, etc. A multi-core processor may be symmetric or asymmetric.

To enable user interaction with the computing device architecture 900, input device 945 can represent any number of input mechanisms, such as a microphone for speech, a touch-sensitive screen for gesture or graphical input, keyboard, mouse, motion input, speech and so forth. Output device 935 can also be one or more of a number of output mechanisms known to those of skill in the art, such as a display, projector, television, speaker device, etc. In some examples, multimodal computing devices can enable a user to provide multiple types of input to communicate with computing device architecture 900. Communication interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. Storage device 930 can include services 932, 934, 936 for controlling processor 910. Other hardware or software modules or engines are contemplated. Storage device 930 can be connected to the computing device connection 905. In one aspect, a hardware module that performs a particular function can include the software component stored in a computer-readable medium in connection with the necessary hardware components, such as processor 910, connection 905, output device 935, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects or examples. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that aspects and examples may be practiced without these specific details. For clarity of explanation, in some examples the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other examples, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects and examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects and examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The various illustrative logical blocks, modules, engines, circuits, and algorithm steps described in connection with the aspects and examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communications, comprising: at least one memory; and at least one processor coupled to the at least one memory and configured to: transmit a message including location data and route data associated with the apparatus to request adjustment of a route of one or more aerial vehicles; receive a response to the message from the one or more aerial vehicles, the response indicating acceptance of the message to adjust the route of the one or more aerial vehicles; and adjust at least one of the route data of the apparatus based on the response or cause adjustment of the route of the one or more aerial vehicles based on the message.

Aspect 2. The apparatus of Aspect 1, wherein the at least one processor is configured to: transmit, based on the acceptance of the message an updated message indicating updated location data and updated route data associated with the apparatus.

Aspect 3. The apparatus of any of Aspects 1 to 2, wherein the at least one processor is configured to: receive an updated response to the updated message from the one or more aerial vehicles, the updated response indicating an updated route of the one or more aerial vehicles.

Aspect 4. The apparatus of any of Aspects 1 to 3, wherein the location data includes a latitude, a longitude, and an altitude of the apparatus.

Aspect 5. The apparatus of any of Aspects 1 to 4, wherein the route data includes a sequence of waypoints over a predetermined period of time, each waypoint of the sequence of waypoints indicating an expected latitude, an expected longitude, and an expected altitude of the apparatus for a point in time over the predetermined period of time.

Aspect 6. The apparatus of any of Aspects 1 to 5, wherein the route of the one or more aerial vehicles includes information indicating a starting location of the route, a target location of the route, and steering data indicating an intended piloting operation to be performed by the one or more aerial vehicles to travel along the route.

Aspect 7. The apparatus of any of Aspects 1 to 6, wherein the intended piloting operation is at least one of an operation to maintain direction, an operation to adjust lateral direction, an operation to adjust altitude, an operation to decrease speed, or an operation to increase speed.

Aspect 8. The apparatus of any of Aspects 1 to 7, wherein at least one of the message or the response includes information indicating whether the one or more aerial vehicles are manned, unmanned, or delivering goods.

Aspect 9. The apparatus of any of Aspects 1 to 8, wherein the route data includes a heading of the apparatus, the heading indicating a horizontal angle of direction and a vertical angle of direction of the apparatus in traveling along the route.

Aspect 10. The apparatus of any of Aspects 1 to 9, wherein the message includes a list of aerial vehicles from the one or more aerial vehicles that have accepted the message to request the adjustment of the route of the one or more aerial vehicles.

Aspect 11. The apparatus of any of Aspects 1 to 10, wherein the one or more aerial vehicles are unmanned aerial vehicles (UAVs).

Aspect 12. A method comprising: transmitting a message including location data and route data associated with an apparatus to request adjustment of a route of one or more aerial vehicles; receiving a response to the message from the one or more aerial vehicles, the response indicating acceptance of the message to adjust the route of the one or more aerial vehicles; and adjusting at least one of the route data of the apparatus based on the response or cause adjustment of the route of the one or more aerial vehicles based on the message.

Aspect 13. The method of Aspect 12, further comprising: transmitting, based on the acceptance of the message an updated message indicating updated location data and updated route data associated with the apparatus.

Aspect 14. The method of any of Aspects 12 to 13, further comprising: receiving an updated response to the updated message from the one or more aerial vehicles, the updated response indicating an updated route of the one or more aerial vehicles.

Aspect 15. The method of any of Aspects 12 to 14, wherein the location data includes a latitude, a longitude, and an altitude of the apparatus.

Aspect 16. The method of any of Aspects 12 to 15, wherein the route data includes a sequence of waypoints over a predetermined period of time, each waypoint of the sequence of waypoints indicating an expected latitude, an expected longitude, and an expected altitude of the apparatus for a point in time over the predetermined period of time.

Aspect 17. The method of any of Aspects 12 to 16, wherein the route of the one or more aerial vehicles includes information indicating a starting location of the route, a target location of the route, and steering data indicating an intended piloting operation to be performed by the one or more aerial vehicles to travel along the route.

Aspect 18. The method of any of Aspects 12 to 17, wherein the intended piloting operation is at least one of an operation to maintain direction, an operation to adjust lateral direction, an operation to adjust altitude, an operation to decrease speed, or an operation to increase speed.

Aspect 19. The method of any of Aspects 12 to 18, wherein at least one of the message or the response includes information indicating whether the one or more aerial vehicles are manned, unmanned, or delivering goods.

Aspect 20. The method of any of Aspects 12 to 19, wherein the route data includes a heading of the apparatus, the heading indicating a horizontal angle of direction and a vertical angle of direction of the apparatus in traveling along the route.

Aspect 21. The method of any of Aspects 12 to 20, wherein the message includes a list of aerial vehicles from the one or more aerial vehicles that have accepted the message to request the adjustment of the route of the one or more aerial vehicles.

Aspect 22. The method of any of Aspects 12 to 21, wherein the one or more aerial vehicles are unmanned aerial vehicles (UAVs).

Aspect 23. A non-transitory computer-readable medium having stored thereon instructions that, when executed by at least one processor, cause the at least one processor to perform one or more of operations according to any of Aspects 12 to 22.

Aspect 24. An apparatus for wireless communication, the apparatus comprising one or more means for performing operations according to any of Aspects 12 to 22.

What is claimed is:

1. An apparatus for wireless communications, comprising:
at least one memory; and
at least one processor coupled to the at least one memory and configured to:
transmit a message including location data and route data associated with the apparatus to request adjustment of a route of one or more aerial vehicles;
receive a response to the message from the one or more aerial vehicles, the response indicating acceptance of the message to adjust the route of the one or more aerial vehicles; and
adjust at least one of the route data of the apparatus based on the response or cause adjustment of the route of the one or more aerial vehicles based on the message.

2. The apparatus of claim 1, wherein the at least one processor is configured to:
transmit, based on the acceptance of the message an updated message indicating updated location data and updated route data associated with the apparatus.

3. The apparatus of claim 2, wherein the at least one processor is configured to:
receive an updated response to the updated message from the one or more aerial vehicles, the updated response indicating an updated route of the one or more aerial vehicles.

4. The apparatus of claim 1, wherein the location data includes a latitude, a longitude, and an altitude of the apparatus.

5. The apparatus of claim 1, wherein the route data includes a sequence of waypoints over a predetermined period of time, each waypoint of the sequence of waypoints indicating an expected latitude, an expected longitude, and an expected altitude of the apparatus for a point in time over the predetermined period of time.

6. The apparatus of claim 1, wherein the route of the one or more aerial vehicles includes information indicating a starting location of the route, a target location of the route, and steering data indicating an intended piloting operation to be performed by the one or more aerial vehicles to travel along the route.

7. The apparatus of claim 6, wherein the intended piloting operation is at least one of an operation to maintain direction, an operation to adjust lateral direction, an operation to adjust altitude, an operation to decrease speed, or an operation to increase speed.

8. The apparatus of claim 1, wherein at least one of the message or the response includes information indicating whether the one or more aerial vehicles are manned, unmanned, or delivering goods.

9. The apparatus of claim 1, wherein the route data includes a heading of the apparatus, the heading indicating a horizontal angle of direction and a vertical angle of direction of the apparatus in traveling along the route.

10. The apparatus of claim 1, wherein the message includes a list of aerial vehicles from the one or more aerial vehicles that have accepted the message to request the adjustment of the route of the one or more aerial vehicles.

11. The apparatus of claim 1, wherein the one or more aerial vehicles are unmanned aerial vehicles (UAVs).

12. A method comprising:
transmitting a message including location data and route data associated with an apparatus to request adjustment of a route of one or more aerial vehicles;
receiving a response to the message from the one or more aerial vehicles, the response indicating acceptance of the message to adjust the route of the one or more aerial vehicles; and
adjusting at least one of the route data of the apparatus based on the response or cause adjustment of the route of the one or more aerial vehicles based on the message.

13. The method of claim 12, further comprising:
transmitting, based on the acceptance of the message an updated message indicating updated location data and updated route data associated with the apparatus.

14. The method of claim 13, further comprising:
receiving an updated response to the updated message from the one or more aerial vehicles, the updated response indicating an updated route of the one or more aerial vehicles.

15. The method of claim 12, wherein the location data includes a latitude, a longitude, and an altitude of the apparatus.

16. The method of claim 12, wherein the route data includes a sequence of waypoints over a predetermined period of time, each waypoint of the sequence of waypoints indicating an expected latitude, an expected longitude, and an expected altitude of the apparatus for a point in time over the predetermined period of time.

17. The method of claim 12, wherein the route of the one or more aerial vehicles includes information indicating a starting location of the route, a target location of the route, and steering data indicating an intended piloting operation to be performed by the one or more aerial vehicles to travel along the route.

18. The method of claim 17, wherein the intended piloting operation is at least one of an operation to maintain direction, an operation to adjust lateral direction, an operation to adjust altitude, an operation to decrease speed, or an operation to increase speed.

19. The method of claim 12, wherein at least one of the message or the response includes information indicating whether the one or more aerial vehicles are manned, unmanned, or delivering goods.

20. A non-transitory computer-readable medium having stored thereon instructions that, when executed by at least one processor, cause the at least one processor to:
transmit a message including location data and route data associated with an apparatus to request adjustment of a route of one or more aerial vehicles;
receive a response to the message from the one or more aerial vehicles, the response indicating acceptance of the message to adjust the route of the one or more aerial vehicles; and
adjust at least one of the route data of the apparatus based on the response or cause adjustment of the route of the one or more aerial vehicles based on the message.
